(19) United States
(12) Patent Application Publication
(10) Pub. No.: US 2023/0266945 A1
(43) Pub. Date: Aug. 24, 2023

(54) CHAOTIC PHYSICAL TRUE RANDOM NUMBER GENERATOR AND ASSOCIATED METHOD

(71) Applicants: UNIVERSITE GRENOBLE ALPES, Saint Martin D'Heres (FR); CENTRE NATIONAL DE LA RECHERCHE SCIENTIFIQUE, Paris (FR); INSTITUT POLYTECHNIQUE DE GRENOBLE, Grenoble (FR)

(72) Inventors: Martial Joseph DEFOORT, Grenoble (FR); Skandar BASROUR, Grenoble (FR); Laurent Rene FESQUET, Sassenage (FR)

(21) Appl. No.: 18/006,456

(22) PCT Filed: Jul. 20, 2021
(86) PCT No.: PCT/EP2021/070299

§ 371 Date: Jan. 23, 2023

(30) Foreign Application Priority Data
Jul. 23, 2020 (FR) FR2007766

(51) Int. Cl. G06F 7/58

(52) U.S. Cl. CPC G06F 7/588

(57) ABSTRACT

A chaotic physical true random number generator and the generation method associated therewith. The generator includes a resonator 2, an analog-to-digital converter configured to convert an analog signal originating from the resonator into a digital signal 104, a digital processing device configured to generate a sequence of true random numbers on the basis of the digital signal 104, and a device for exciting the resonator configured to excite the resonator with a determined excitation signal to set it in a dynamic multi-stability mode, and modulate the excitation signal, so that the resonant physical component has a chaotic behaviour and that the analog signal is representative of the chaotic behaviour of the resonator. A gain in terms of simplicity of implementation, bulk and/or manufacturing cost is thus achieved for making physical true random number generators in one or more embodiments.

### TECHNICAL FIELD

The present invention relates to the field of devices and methods for generating true random numbers. More particularly, according to two of its aspects, the present invention relates to a chaotic physical true random number generator and the generation method associated thereto. For example, the generation of true random numbers is essential to modern cryptography, generating the keys allowing communicating securely.

### PRIOR ART

To obtain a sequence of true random numbers, it is known to rely on an intrinsically random physical process. Since the amplitude of the associated signals could be low, it might be necessary to amplify them before converting them into a sequence of true random numbers. This quest for sources of amplified randomness leading to a random digital sequence is a topic in constant progress.

The physical generation of true random numbers is based on such inherently random physical processes. In particular, it is known to exploit different physical phenomena, including:
the thermal noise [S. K. Mathew et al., “2.4 Gbps, 7 mW All-Digital PVT-Variation Tolerant True Random Number Generator for 45 nm CMOS High-Performance Microprocessors,” in IEEE Journal of Solid-State Circuits, vol. 47, no. 11, pp. 2807-2821, November 2012], or
the variation of the frequency of a clock [Fischer V. et al. (2003) True Random Number Generator Embedded in Reconfigurable Hardware. In: Kaliski B. S., Koç. K., Paar C. (eds) Cryptography Hardware and Embedded Systems—CHES 2002. Lecture Notes in Computer Science, vol 2523. Springer, Berlin, Heidelberg].

These phenomena can be observed directly on resonant components, or resonators, of an electrical circuit, but can also be observed directly on resonators equipping devices belonging to other fields.

For example, it has been demonstrated that the chaotic behaviour of optical components can be exploited, in particular by using lasers and photo-detectors as resonators [Uchida, A., Amano, K., Inoue, M., Hirano, K., Naito, S., Someya, H., . . . & Yoshimura, K. (2008). Fast physical random bit generation with chaotic semiconductor lasers. Nature Photonics, 2(12), 728].

Micro/Nano-Electro-Mechanical Systems (M/NEMS) are another example of resonant devices. Some of their resonant components exploit mechanical properties, allowing converting a mechanical movement directly into an electrical signal. These components are ubiquitous in modern technologies, and are used in particular as sensors in the form of accelerometers, gyrometers or magnetometers [Tanaka, M. (2007). An industrial and applied review of new MEMS devices features, Microelectronic engineering, 84(5-8), 1341-1344]. Among the different intrinsic properties of these resonators, some are sources of randomness, including:
the thermomechanical noise [T. B. Gabrielson et al. “Mechanical-thermal noise in micromachined acoustic and vibration sensors”, in IEEE Transactions on Electron Devices, vol. 40, no. 5, p. 903-909, May 1993, doi: 10.1109/16.210197], and
the noise in 1/f of their resonance frequency [M. Sansa et al. Frequency fluctuations in Silicon nanoresonators, Nat. Nanotechnol. 11, 552-558 (2016)].

Thanks to their intrinsic non-linearity, it is possible to set these resonators in a chaotic mode [Y. C. Wang et al. “Chaos in MEMS, parameter estimation and its potential application,” in IEEE Transactions on Circuits and Systems I: Fundamental Theory and Applications, vol. 45, no. 10, pp. 1013-1020, October 1998].

As mentioned hereinabove, in order to create a physical generator of true random numbers, the intrinsic noise of the exploited resonator should be amplified. In the field of electronic circuits, it is possible to amplify noise, as a source of randomness, in particular by exploiting the sensitiveness of the chaotic mode to the conditions in which the resonator is initially located [M. E. Yalcin et al. “True random bit generation from a double-scroll attractor,” in IEEE Transactions on Circuits and Systems I: Regular Papers, vol. 51, no. 7, pp. 1395-1404, July 2004].

Moreover, there are oscillating devices. Such devices are for example described in the article of Ghosh Dia et al., entitled “Generation & control of chaos in a single loop optoelectronic oscillator” and published in the journal Optik. These devices are not comparable to the resonant devices introduced hereinabove. Indeed, an oscillating device generally comprises a closed loop, responding to well-defined constraints; its very physics are fundamentally different from those of a resonant device. In particular, an oscillator “affects itself” to the extent that its circuit is looped, while a resonant device or resonator has no feedback loop.

An object of the present invention is to overcome at least one drawback of known physical true random number generators.

More particularly, an object of the present invention is to provide a chaotic physical true random number generator allowing for a gain in simplicity of implementation, in size and/or in manufacturing cost, in comparison with existing chaotic physical true random number generators.

Another object of the present invention is to provide a physical true random number generator compatible with many existing technologies, and in particular CMOS technologies (standing for “Complementary Metal Oxide Semiconductor”), preferably without additional bulk or manufacturing cost.

Other purposes, characteristics and advantages of this invention will appear upon reading the following description and its accompanying drawings. It is understood that other advantages can be incorporated thereto.

### SUMMARY

To achieve this objective, according to a first aspect of the invention, an excitation system for a resonant physical component is provided, the system comprising an excitation device configured to:
Excite the resonant physical component with a determined excitation signal to set, and possibly to maintain at least temporarily, the resonant physical component in a dynamic multi-stability mode, and
Modulate the excitation signal,
   so that the resonant physical component has a chaotic behaviour and that an analog signal originating from the resonant physical component is directly or indirectly representative of the chaotic behaviour of the resonant physical component.

Furthermore, the excitation system has no feedback loop.

Note that the modulation of the excitation signal may comprise phase and/or frequency and/or amplitude modulation by a modulating signal.

According to a second aspect of the invention, chaotic physical true random number generator is provided comprising:
A resonant physical component,
An analog-to-digital converter configured to convert an analog signal originating from the resonant physical component into a digital signal representative of the analog signal,
A digital processing device configured to generate a sequence of true random numbers on the basis of said digital signal.

The generator further comprises a device for exciting the resonant physical component configured to:
Excite the resonant physical component with a determined excitation signal to set, and possibly to maintain at least temporarily, the resonant physical component in a dynamic multi-stability mode, and
modulate the excitation signal.

The excitation device has no feedback loop.

Thus, the resonant physical component has a chaotic behaviour and the analog signal to be converted is directly or indirectly representative of the chaotic behaviour of the resonant physical component.

By setting the resonant physical component in a dynamic multi-stability mode by applying an excitation signal, and by further modulating the excitation signal, the behaviour of the resonant physical component can become chaotic. The noise sources intrinsic to the resonant physical component are then amplified, for example exponentially, and a high-amplitude noise is obtained. The analog signal originating from the resonant physical component is then representative of the chaotic behaviour of the resonant physical component. Henceforth, it is possible to use it to generate a sequence of true random numbers. Considering that, barring exceptions, any micro-electromechanical system comprises a physical component capable of acting as a resonator for the generator according to the second aspect of the invention, it should be understood that the excitation system according to the first aspect of the invention allows for a gain in simplicity of implementation, in size and/or in manufacturing cost for making chaotic physical true random number generators, in particular in comparison with generators based on oscillating devices (with a feedback loop). It should be further understood that the excitation system according to the first aspect of the invention is compatible with many existing technologies, and in particular CMOS technologies, potentially with a small size or a limited additional manufacturing cost.

According to a third aspect of the invention, a true random number generation method is provided, in particular implementing a chaotic physical generator as introduced herein, comprising the following steps:
Excitation of a resonant physical component with a determined excitation signal to set, and possibly to maintain at least temporarily, the resonant physical component in a dynamic multi-stability mode,
Modulation of the excitation signal, so that the resonant physical component has a chaotic behaviour,
   The excitation and modulation steps being implemented by an excitation device with no feedback loop,
Acquisition of an analog, and more particularly electrical, signal originating from the resonant physical component and directly or indirectly representative of the chaotic behaviour of the resonant physical component,
Conversion of the analog signal into a digital signal representative of the acquired analog signal, then
Generation of a sequence of true random numbers on the basis of said digital signal.

According to a fourth aspect of the invention, a computer program product is provided comprising instructions, which when performed by at least one processor, executes at least the steps of the true random number generation method as introduced herein.

According to a fifth aspect of the invention, a micro-electromechanical system is provided comprising a resonant physical component, an analog-to-digital converter and a digital processing device, further comprising an excitation device configured to excite the resonant physical component so as to form a chaotic physical true random number generator as introduced herein.

Optionally, the excitation system according to the first aspect of the invention may also have at least any one of the following features:

For example, the excitation system is intended to be integrated into a micro-electromechanical system comprising a resonant physical component for use thereof in the generation of a sequence of true random numbers on the basis of said analog signal;

For example, the excitation system further comprises:
An analog-to-digital converter configured to convert the analog signal originating from the resonant physical component into a digital signal representative of the analog signal,
A digital processing device configured to generate a sequence of true random numbers on the basis of said digital signal;

For example, the excitation system further comprises:
a demodulation device configured to implement either one of the following steps:
   i. before conversion of the analog signal, a demodulation of the analog signal at the frequency f of the excitation signal, and
   ii. after conversion of the analog signal, demodulation of the digital signal at the frequency f of the excitation signal;

Optionally, the chaotic physical generator according to the second aspect of the invention may further have at least any one of the following features:

For example, the analog signal to be converted is representative of the changes in amplitude and/or phase of vibration of the resonant physical component excited by the modulated excitation signal;

Preferably, the generator is free of any type of excitation devices configured to buckle the resonant physical component;

For example, said dynamic multi-stability mode is a non-linear dynamic bistable mode called Duffing mode.

For example, said excitation signal has a peak voltage comprised between 0.01 and 10V, preferably comprised between 0.1 and 5V, and a frequency f equal to the resonance frequency f₀ of the resonant physical component within a 20% margin, preferably within a 10% margin.

For example, said modulated excitation signal has a modulation frequency δf preferably higher than, yet potentially substantially equal to, the ratio f₀/Q of the resonance frequency f₀ of the resonant physical component to its quality factor Q.

For example, the resonant physical component comprises a micro/nano-resonator, such as a double-embedded micro/nano-beam.

For example, the generator further comprises a demodulation device configured to implement either one of the following steps:
before conversion of the analog signal, a demodulation of the analog signal at the frequency f of the excitation signal, and
after conversion of the analog signal, a demodulation of the digital signal at the frequency f of the excitation signal.

Optionally, the generation method according to the third aspect of the invention may further have at least any one of the following features:

For example, the method may further comprise, after the step of acquiring the analog signal and before the step of converting the analog signal, a step of amplifying the acquired analog signal;

For example, the excitation signal is parameterised to set, and possibly to maintain at least temporarily, the resonant physical component in a non-linear dynamic bistable mode called Duffing mode;

For example, the dynamic multi-stability mode of the resonant physical component being associated with a continuous and limited frequency domain, the frequency f of the excitation signal is determined to set the resonant physical component in a sub-mode of the dynamic multi-stability mode, said sub-mode being associated with a first half, and possibly a first third, of the frequency domain associated with the dynamic multi-stability mode of the resonant physical component;

For example, the excitation of the resonant physical component comprises the application at its terminals, as an excitation signal, of a peak voltage comprised between 0.01 and 10V, and preferably comprised between 0.1 and 5V, and a frequency f equal to the resonance frequency f₀ of the resonant physical component within a 20% margin, preferably within a 10% margin;

For example, the potential of the resonant physical component in its dynamic multi-stability mode having two distinct wells:
The frequency modulation of the excitation signal has a determined amplitude δf to induce changes in the state of the resonant physical component in its dynamic multi-stability mode from one of the two potential wells to the other, and vice versa, and/or
The amplitude modulation of the excitation signal has a determined amplitude δf to induce changes in the state of the resonant physical component from its monostable mode to its dynamic multi-stability mode, and vice versa;

For example, the excitation signal is modulated with a modulation frequency δf preferably higher than, yet potentially substantially equal to, the ratio f₀/Q of the resonance frequency f₀ of the resonant physical component to its quality factor Q;

For example, the method further comprises either one of the following steps:
before conversion of the analog signal, a demodulation of the analog signal at the frequency f of the excitation signal, and
after conversion of the analog signal, demodulation of the digital signal at the frequency f of the excitation signal;

For example, the analog signal being a first analog signal directly representative of the changes in amplitude and/or phase of vibration of the resonant physical component, the demodulation of the analog signal before conversion of the analog signal comprises a comparison of the first analog signal with the excitation signal to deduce, as an analog signal indirectly representative of the changes in amplitude and/or phase of vibration of the resonant physical component, a second analog signal representative of a change in amplitude of the first analog signal and/or a change in phase between the first analog signal and the excitation signal;

For example, the conversion of the analog signal comprises sampling of the analog signal at a sampling frequency or in steps selected according to the voltage of the excitation signal and a modulation frequency δf with which the excitation signal is modulated; Preferably, the sampling frequency is at least 10 times higher than the modulation frequency δf;

For example, an analog signal representative of the changes in amplitude of vibration of the resonant physical component and an analog signal representative of changes in phase of the resonant physical component being acquired during the acquisition step, the conversion step comprises the conversion of each of these two analog signals into a digital signal;

For example, the analog signal being converted into a succession of values each encoded over a number N of bits, for example strictly greater than three, typically equal to eight, the generation of the binary sequence of true random numbers comprises the generation of a series of bits that can be illustrated in the form of a square signal, then splitting this series into a sequence of bit blocks on the basis of each of which a true random number of the sequence is generated;

For example, said series of bits is generated according to only the n-bits with the lowest weight of each encoded value of the succession;

For example, the generation of the binary sequence of random numbers comprises the generation of a series of bits that can be illustrated in the form of a square signal for each of the acquired two analog signals, then a logical operation, for example by the “Exclusive or” operator, between the generated two series of bits, to obtain the series of bit blocks to be split.

By a parameter “substantially equal to” a given value, it should be understood that this parameter is equal to the given value, within a 10% margin, and possibly within a 5% margin, from this value.

### BRIEF DESCRIPTION OF THE FIGURES

The aims, purposes, characteristics and advantages of the invention will be better understood upon reading the detailed description of one embodiment thereof, which is illustrated by means of the following accompanying drawings, in which:

FIG. 1 represents an electronic diagram of an embodiment of the second and fifth aspects of the invention and comprising an electronic diagram of an embodiment of the first aspect of the invention.

FIG. 2 graphically represents the switch from a monostable mode (bottom curve) in a dynamic bistable mode called Duffing mode (top curves).

FIGS. 3A and 3B represent: A) the so-called Duffing dynamic bistable mode by a graph of the amplitude of vibration of the resonant physical component as a function of the excitation frequency applied thereto and B) the two-well potential of the resonant physical component according to its amplitude of vibration. In both figures, the arrow represents a schematic guide describing the switch from a high amplitude to a low amplitude within the hysteresis.

FIG. 4 graphically illustrates possible behaviours of the resonant physical component when the latter is excited by the modulated excitation signal.

FIG. 5 graphically illustrates an embodiment of the step of converting each of two analog signals representative of the amplitude and the phase of the considered resonant physical component, into a digital signal on the basis of which a sequence of true random numbers is to be generated.

FIG. 6 is a flowchart of an embodiment of the generation method according to the third aspect of the invention.

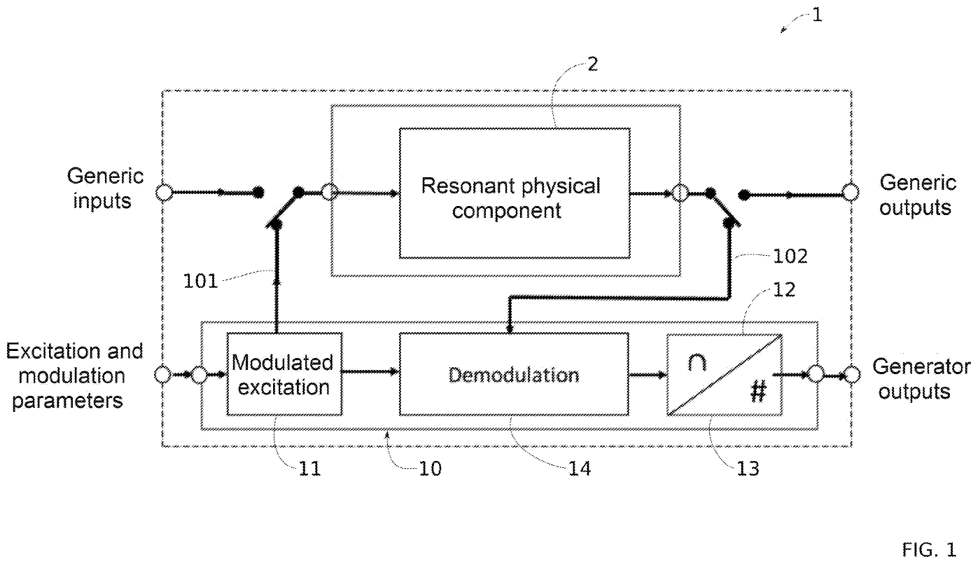

The drawings are provided by way of example and are not intended to limit the scope of the invention. They constitute diagrammatic views intended to ease the understanding of the invention and are not necessarily to the scale of practical applications. In particular, FIGS. 1, 4 and 5 are not necessarily representative of reality.

### DETAILED DESCRIPTION

The generation of true random numbers is essential to modern cryptography. In particular, it allows generating the keys securing communications. To obtain a sequence of true random numbers, the present invention suggests relying on an intrinsically random physical process. Different aspects of the invention are described hereinbelow, with reference to the appended figures, which comprise an excitation system 10 of a resonant physical component 2, a chaotic physical true random number generator 1 which can form at least one portion of a micro-electromechanical system, and a true random number generation method 100 associated with the generator 1.

Next, we will sometimes use the term “resonator” to refer to the above-mentioned resonant physical component 2.

More particularly, the invention suggests exploiting the capability that most resonant physical components have to exhibit a chaotic behaviour when they are excited in an ad hoc manner. Such resonant physical components are already present in many technologies; and the invention presents as first technical advantage showing how it is possible to use the aforementioned capability of resonators, already implemented in many apparatuses, in particular electronic ones, to generate true random numbers by diverting these components from their primary uses. Thus, a person skilled in the art will appreciate upon reading what follows that the invention according to some of its aspects, provides for the possibility of adding, to an existing apparatus, in particular an electronic one, which comprises a resonator 2, some on-board components, and in particular a device 11 for exciting the resonator 2, to divert the latter from its primary use, in order to use it for the generation 150 of a sequence of true random numbers. Hence, the proposed solution allows conferring on most existing apparatuses, in particular electronic ones, an additional function that can be used directly by these same apparatuses, and/or by others connected thereto, in particular in order to enable these apparatuses to communicate in a secure way. A person skilled in the art will note, upon reading what follows, that this additional functionalisation is also made possible without inducing:
significant bulk problems, in particular for apparatuses that are intended to be increasingly miniaturised, and/or
a significant additional manufacturing cost.

It is also quite possible that the apparatuses, in particular electronic ones, already manufactured can be modified at lower cost so as to embed therein the device(s) allowing conferring thereon the additional function of true random number generator 1. FIG. 1 can be viewed as illustrating an electronic diagram comprising an excitation system 10 added to the terminals of a resonator 2 equipping an existing micro-electromechanical system. Switching means, herein represented in the form of switches, can then be provided which are configured to functionally connect the excitation system 10 to the terminals of the resonator 2, and to disconnect the terminals of the resonator 2 from these generic inputs and outputs. The excitation system 10 as illustrated in FIG. 1 comprises the excitation device 11, the input data of which comprise the parameters of excitation of the resonator 2 and of modulation of this excitation, a demodulation device 14, an analog-to-digital converter 12 and a digital processing device 13, as described hereinbelow. However, as this will become clear from the following description, the excitation system 10 comprises only in its most generic version the excitation device 11, the other components of the excitation system 10 as illustrated in FIG. 1 which may belong to an existing micro-electromechanical system 1.

It should be noted that, amongst the existing technologies compatible with the implementation of the invention, the CMOS technologies in particular are directly compatible with this implementation.

Micro/nano-electromechanical systems can be defined as micro/nano-sized devices that convert a mechanical process into the electrical domain, and vice versa. Micro/nano-electromechanical systems comprising at least one resonant physical component 2 have the particularity of having, through their resonant physical component(s), a vibrating mass allowing transferring mechanical energy into electrical energy, or vice versa, for example to obtain an energy recuperator or a force sensor, depending on the selected geometry.

Resonant micro/nano-electromechanical systems are primarily characterised by their resonance frequency f₀ and their quality factor Q.

One of the geometries that can be used in the context of the present invention consists for example of a double-embedded micro/nano-beam. Indeed, the equilibrium position of the beam, as a resonator 2, can alternate between different remarkable states, in particular when the beam is set in a dynamic multi-stability mode. Reaching such a mode is possible by applying a sufficiently high reciprocating force on the beam. In all cases, the application of such a force can be considered as consisting in the application of an excitation signal of the resonator 2. This is the first role that the excitation device 11 can fill, according to the present invention. According to the considered example, the position of the beam subjected to such an excitation signal can then resonate between states close to said remarkable states and/or around these remarkable states.

Depending on the nature of the resonator 2, the excitation signal may consist of an alternating voltage applied at its terminals. In which case, the excitation signal can be characterised according to parameters of said alternating voltage such as its peak voltage, also called “excitation voltage” later on, and its frequency f, also called “excitation frequency”. For example, the excitation signal has a peak voltage comprised between 0.01 and 10V, preferably comprised between 0.1 and 5V, and a frequency f equal to the resonance frequency f₀ of the resonator 2 within a 20% margin, preferably within a 10% margin. It should be noted that the excitation signal is not limited to an electrical signal, but extends for example also to a mechanical signal to which the resonator 2 would be sensitive by its nature.

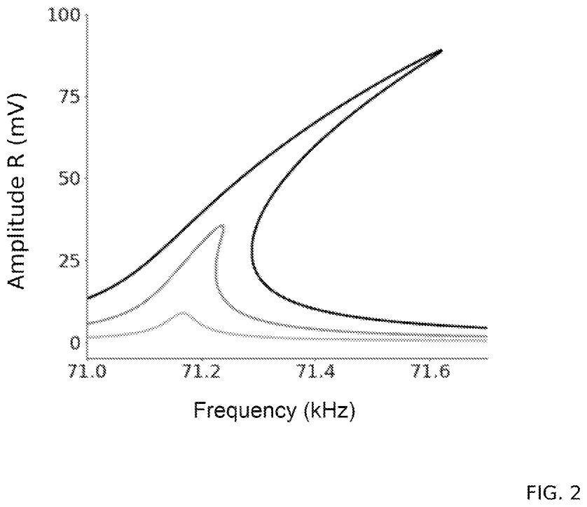

More generally, any resonant physical component 2 can be excited 110 with a determined excitation signal to set, and possibly to maintain, at least temporarily, the resonant physical component 2 in a dynamic multi-stability mode. Referring to FIG. 2, showing a graph comprising several curves derived from digital simulations, it is observed that the response in terms of amplitude R(mV) of variation of a resonator 2 as a function of the frequency of a low excitation signal (lower curve) is in the form of a Lorentzian illustrating the linear behaviour of the resonator 2 when it is subjected to a low excitation force. By increasing the excitation force applied to the resonator 2, its response is progressively transformed and becomes asymmetrical (cf. the upper curves); the response of the resonator 2 becomes non-linear, which results in modifying its resonance frequency f₀. A frequency hysteresis is then observed which, in the illustrated case, is representative of a dynamic bistable mode, and more particularly herein of a non-linear dynamic bistable mode called Duffing mode.

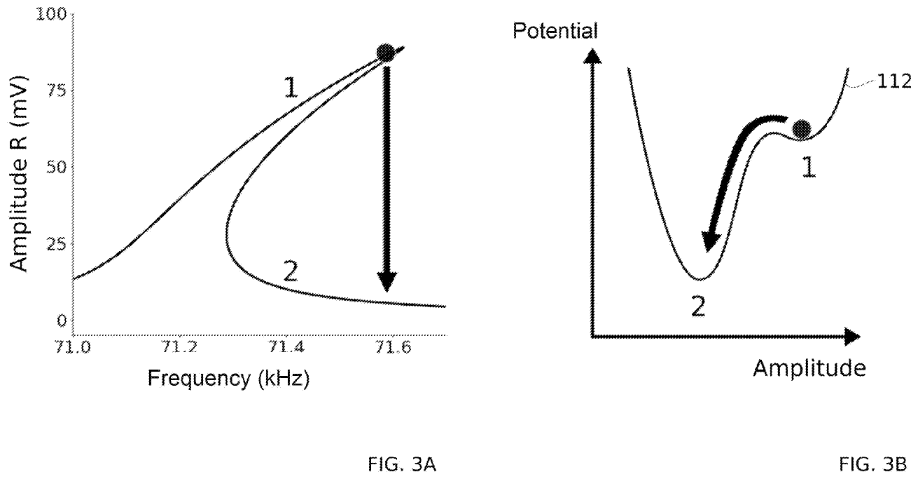

The upper curve illustrated in the graph of FIG. 2 is replicated in the graph of FIG. 3A. On the latter, references “1” and “2” have been added which roughly point to distinct remarkable states in which the resonator 2 can substantially be found for a given excitation frequency. The references “1” and “2” are replicated correspondingly in FIG. 3B which shows, for said given excitation frequency, the evolution of the potential of the resonator 2 as a function of the amplitude R(mV) of its variations. Thus, the curve illustrated on the graph of FIG. 3B shows that each of the remarkable states referenced “1” and “2” corresponds to a state of least potential, i.e. to a potential well. Hence, the aforementioned remarkable states correspond to preferable stable states around each of which the resonator 2 will have a greater probability of being found for said given excitation frequency. Thus, the graphs of FIGS. 3A and 3B illustrate a bifurcation between the two stable states of hysteresis. Thus, at high amplitudes of the excitation signal, a hysteresis opens in the frequency domain, favouring the state of high-amplitude variation “1” or the state of low-amplitude variation “2”. These two states are directly comparable with the case of a buckled resonator, with the difference that the states of the latter are static (for example, they correspond to the high and low positions of a buckled beam), while the two states of the resonator 2 set according to the invention in a dynamic multi-stability mode are dynamic (they correspond to high or low amplitudes of vibration of the resonator 2). As with the case of a buckled resonator, it is possible to impose, on the resonator 2 set according to the invention in a dynamic multi-stability mode, a chaotic behaviour by modulating the excitation force that is applied thereto.

It should be noted herein that the excitation signal according to the invention is in no way intended to make the resonator 2 buckle. Preferably, the excitation system 10 according to the first aspect of the invention and/or the chaotic physical generator 1 according to the second aspect of the invention are free of any type of excitation device configured to make the resonator 2 buckle. Thus, the implementation of the invention is not conditional on making of a buckled structure, such making being complex in terms of manufacture and generally requiring high energy consumption to operate. On the contrary, the implementation of the invention benefits from the fact that almost any micro/nano-resonator 2 features a non-linear behaviour at high excitation amplitudes, without particular conditions on its geometry, the used material, or on the transduction techniques it implements. In particular, the implementation of the invention can be carried out on most micro/nano-resonators 2 as they exist, and therefore without the need to alter their manufacturing process.

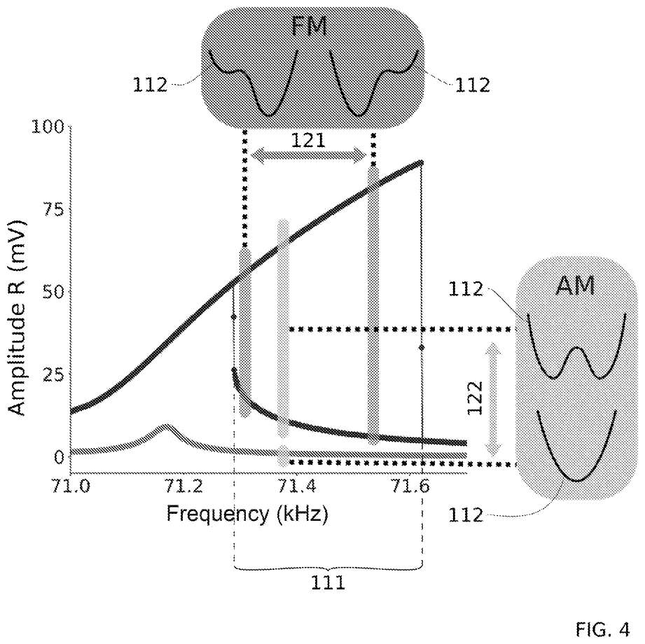

If the excitation signal is further modulated 120, in frequency 121 and/or in amplitude 122, as illustrated in FIG. 4, the resonator 2 can adopt complex, non-periodic, chaotic dynamics. The chaotic behaviour thus generated is characterised in particular by its non-repeatability and the impossibility of predicting the state of the resonator 2 in the mid- and long-terms. Indeed, although any chaotic mode is deterministic, i.e. although the response of the resonator 2 can be predicted if the equations governing its behaviour are perfectly known, a very small variation of the initial conditions, for example of ambient temperature or pressure, in which the resonator 2 is located, quickly leads to considerable changes in behaviour, like the butterfly effect. Thus, the behaviour of any resonator 2 being always affected by the presence of a noise, irrespective of how weak it might be, a drastic change in its response to a modulated excitation signal 101 as mentioned hereinabove can be observed, in particular at each new application of the same modulated excitation signal 101, making the prediction of its dynamic behaviour impossible in the mid- and long-term. This is why a micro/nano-electromechanical system 1 at least one resonator 2 of which is set in a dynamic multi-stability mode and is further disturbed so that the resonator adopts a chaotic behaviour allows generating, at the output of the resonator 2, a random high-amplitude analog signal 102. It should be noted herein that the aforementioned change in behaviour of the resonator 2 can be observed solely on the phase of the analog signal, solely on the amplitude of the analog signal 102, on each of the phase and the amplitude of the analog signal 102, or on any combinations of these two parameters of the analog signal 102; these different possibilities are encompassed by the expression “changes in amplitude and/or phase of vibration of the resonator 2” used hereinbelow.

Note herein that the apparition of the chaotic behaviour of the resonator 2 may, as already implicitly introduced hereinabove, require a certain time from the start of the application of the modulated excitation signal 101. More particularly, this time may be necessary to observe the change in the response of the resonator 2 to the modulated excitation signal 101 as a function of the initial conditions that it experiences. A person skilled in the art will be able to assess this time a priori or heuristically, for example by checking the randomness of the sequence of generated numbers 150, in particular by implementing the reference tests known under the reference NIST 800-22 or AIS 31. The at least temporary maintenance of the resonator 2 in the dynamic multi-stability mode can be considered in particular in light of this time necessary for the expression of the chaotic behaviour of the resonator 2 by the analog signal 102 that is derived therefrom.

Regardless of the initial application of the resonator 2, for example an application as an accelerometer or energy recuperator, the latter can, according to the invention, also be used to generate an analog signal 102 directly or indirectly representative of the chaotic behaviour of the resonator 2 set in a dynamic multi-stability mode, thereby conferring thereon a second function without additional manufacturing cost, without significant additional bulk and/or for a relatively low energy consumption.

As illustrated in FIG. 4, the excitation signal can be modulated 120 in many ways including conventional frequency 121 and/or amplitude 122 modulations. More particularly, the frequency 121 modulation 120 of the excitation signal can be performed at a determined modulation frequency δf to induce changes in the state of the resonator 2 in its dynamic multi-stability mode from one of the two wells of potential to the other, and vice versa, as illustrated by the potential curves 112 surmounted in FIG. 4 by the initials FM standing for “frequency modulation”. Alternatively or complementarily, the amplitude 122 modulation 120 of the excitation signal can be performed at a determined modulation frequency δf to induce changes in the state of the resonator 2 from its monostable mode to its dynamic multi-stability mode, and vice versa, as illustrated by the potential curves 112 surmounted in FIG. 4 by the initials AM standing for “amplitude modulation”. It should be noted herein that the at least temporary maintenance of the resonator 2 in the dynamic multi-stability mode can be considered in particular in light of this possibility that the resonator has to visit its monostable mode, in particular when the modulation 120 comprises an amplitude modulation 122.

To express the foregoing in an alternative and/or complementary way, it is possible to consider that the excitation device 11 of the resonator 2 is configured to:
modulate 120 the excitation signal in frequency 121 with a determined modulation frequency δf to alternately set the resonant physical component from one state to another amongst two states close to the two states of least potential of the resonator 2 when it is in said dynamic bistable mode, and/or
modulate 120 the excitation signal in amplitude 122 with a determined modulation frequency δf to alternately set the resonator 2 from a state close to its monostable state to either one amongst two states close to the two states of lesser potential of the resonator 2 when it is in said dynamic bistable mode.

Preferably, these passages of the resonator 2 between the above-mentioned different states are quick enough for the resonator 2 not to remain for a significant time in a state close to the same state of lesser potential. Said significant time depends on the excitation signal, for example its voltage and/or its frequency. Sufficiently quick transitions of the resonator 2 between the above-mentioned different states are ensured by applying to the resonator 2 a modulated excitation signal 101 having a modulation frequency δf preferably higher than, yet potentially substantially equal to, the ratio f₀/Q of the resonance frequency f₀ of the resonator 2 to its quality factor Q. The parameterisation of said significant time can also be adapted according to the sampling parameters of the analog signal 102. Amongst the sampling parameters, mention may be made of the sampling frequency or the sampling steps, depending on the used sampling method in a manner known to a person skilled in the art.

One could notice, in particular in FIG. 4, that the dynamic multi-stability, or dynamic bistable, mode according to the illustrated example, of the resonator 2 is associated with a continuous and limited frequency domain 111. In this example, note that the frequency f of the excitation signal is preferably determined to set the resonator 2 in a sub-mode of the dynamic bistable mode, this sub-mode being associated with a first half, and possibly with a first third, of the frequency domain associated with the dynamic bistable mode of the resonator 2.

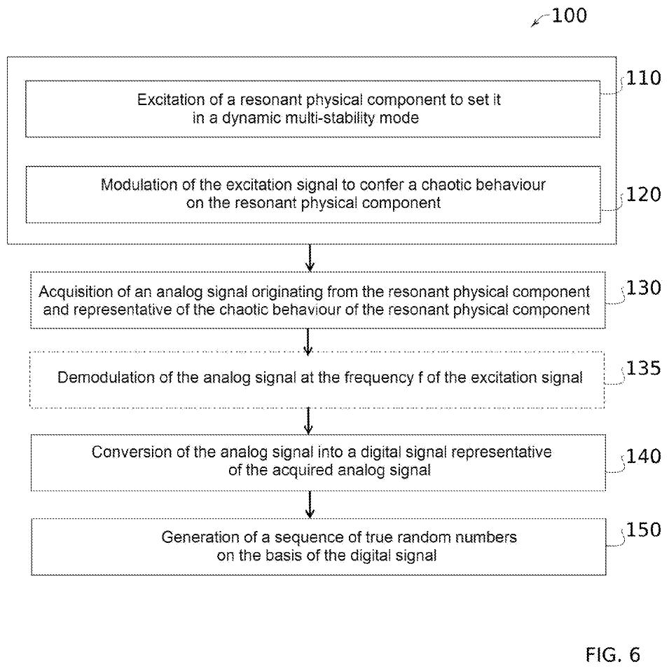

Steps 110 and 120 of the true random number generation method 100 are illustrated in particular in FIG. 6. Although these steps are illustrated there, and described hereinabove, as successive, note that they are not necessarily so. Considered in combination, they consist in applying a modulated excitation signal 101 on the resonator 2.

It is this possible combination that is symbolised by the fact that steps 110 and 120 are represented in FIG. 6 in the same box.

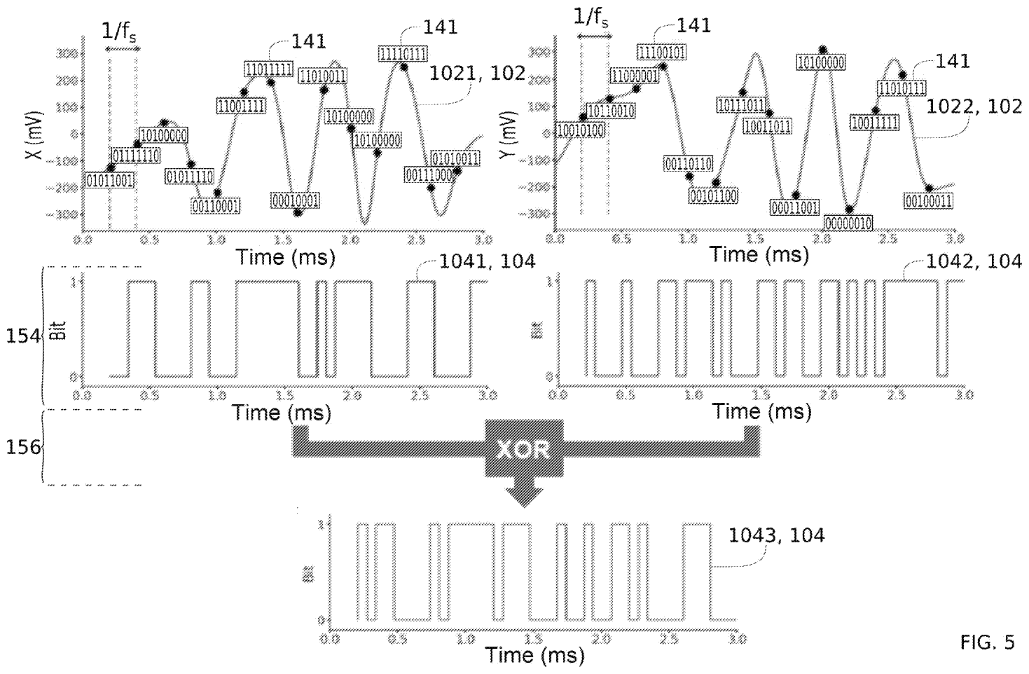

Exploiting the capacity of a resonator 2, such as the aforementioned beam, in this manner to generate, at its output, an analog signal 102 representative of the changes in amplitude and/or phase of vibration of the resonator 2, it is henceforth possible to transform this analog signal 102 into a sequence of true random numbers. The steps of the method 100 relating to this transformation are described hereinbelow, in particular with reference to FIGS. 5 and 6.

To transform the analog signal 102 originating from the resonator 2 into a sequence of true random numbers, provision is made to use an analog-to-digital converter 12 to convert 140 the analog signal 102 into a digital signal 104. Preferably, this conversion 140 is carried out so that the digital signal 104 is representative of the random and high amplitude aspects of the analog signal 102. For this purpose, a person skilled in the art has just to select the parameters of the conversion 140 ad hoc, and in particular the parameters of sampling of the analog signal 102. Sampling of the analog signal 102 may be carried out according to a determined sampling frequency fₛ, or by selected sampling steps, in particular according to the peak voltage of the excitation signal and the modulation frequency δf with which the excitation signal is modulated 120.

Note that most micro/nano-electromechanical systems already ensure the conversion, in a digital binary version, of the analog signal originating from its resonator, by an analog-to-digital converter. The conversion 140 according to the method of the invention may be carried out:
by the converter 12 already provided for in the considered micro/nano-electromechanical system 1, or
by a converter 12 specific to an excitation system 10 according to the first aspect of the invention which would be added to the architecture of a micro/nano-electromechanical system 1 whether the latter already exists or it is being designed.

Once the analog signal 102 has been converted 140 into a digital signal 104 also representative of the chaotic behaviour of the resonator 2, provision is made for a digital processing device 13, such as a processor, to be configured to generate 150, on the basis of this digital signal 104, the sequence of true random numbers.

Note that most micro/nano-electromechanical systems already comprise such a digital processing device 13. Thus, the digital processing 150 according to the method 100 of the invention may:
be made by the processing device 13 already equipping the considered micro/nano-electromechanical system 1, or
be a processing device 13 specific to an excitation system 10 according to the first aspect of the invention which would be added to the architecture of a micro/nano-electromechanical system 1 whether the latter already exists or it is being designed.

As illustrated in FIG. 6, the method 100 according to the third aspect of the invention may further comprise a step consisting in demodulating 135 the analog signal 102 at the frequency f of the excitation signal. This step allows having in the demodulated signal only the information related to the effect of the modulation 120 of the excitation signal. In other words, the signal thus demodulated carries only the information representative of the changes in amplitude and/or phase of vibration of the resonator 2. It should be understood that, although optional, this demodulation step is certainly interesting in that it allows simplifying and/or increasing the efficiency of the subsequent step of generating 150 the sequence of true random numbers, the latter being actually carried out henceforth on the basis of the sole information that is most useful thereto.

It should be noted that the demodulation device 14 allowing implementing step 135 of the method 100 in particular according to its embodiment illustrated in FIG. 6 may:
consist of a device already equipping the considered micro/nano- electromechanical system 1, or
be a device specific to an excitation system 10 according to the first aspect of the invention which would be added to the architecture of a micro/nano-electromechanical system 1 whether the latter already exists or it is being designed.

As mentioned hereinabove, the analog signal 102 originating from the resonator 2 excited by the modulated excitation signal 101 may be directly or indirectly representative of the chaotic behaviour of the resonator 2. Henceforth, the analog signal 102 may be a first analog signal directly representative of the changes in amplitude and/or phase of vibration of the resonator 2. In this case, the demodulation 135 of the analog signal 102 as introduced hereinabove comprises for example a comparison of the first analog signal with the excitation signal to deduce, as an analog signal indirectly representative of the changes in amplitude and/or phase of vibration of the resonator 2, a second analog signal representative of a change in amplitude of the first analog signal and/or a change in phase between the first analog signal and the excitation signal.

Referring to FIG. 5, an analog signal 1021 representative of the changes in amplitude of vibration of the resonant physical component 2 and an analog signal 1022 representative of the changes in phase of the resonator 2 can result from the acquisition step 130 of the analog signal 102 originating from the resonator 2, and in particular from the above-mentioned demodulation step 135. The conversion step 140 then comprises the conversion of each of these two analog signals into a corresponding digital signal 1041, 1042.

More particularly, each analog signal 1021, 1022 being converted 140 into a succession of values 141 each encoded over a number N of bits, equal to eight in the example illustrated by FIG. 5, the generation 150 of the binary sequence of true random numbers may comprise the generation, for each analog signal 1021, 1022, of a series of bits 1041, 1042 which can be illustrated in the form of a square signal.

Referring to FIG. 5, each series of bits 1041, 1042 can be generated 154 according to the sole n-bits with low weight of each value 141. In FIG. 5, only the 3 bits with low weight of each value 141 are used to generate the series of bits 1041 and 1042. The method according to this last feature is particularly advantageous when the chaotic behaviour of the resonator 2 is not sufficient to amplify the noise so significantly that all of the bits of each value 141 would be representative thereof.

Still with reference to FIG. 5, two series of bits 1041 and 1042 being obtained for the two analog signals 1021, 1022, the generation 150 of the binary sequence of true random numbers may further comprise a logical operation 156, for example by the “Exclusive or” operator, between the two series of bits 1041 and 1042, to obtain the series of bit blocks 1043 whose random properties could be more advantageous.

The generation 150 the binary sequence of true random numbers may then comprise splitting (not represented) this series of bit blocks 1043 into a sequence of bit blocks on the basis of each of which a true random number could be generated 150.

A micro-electromechanical system comprising a resonator 2 in the form of a disk with a sub-millimeter diameter and with a thickness substantially equal to 10 microns and whose transduction is performed in a piezoelectric manner has been used to demonstrate the feasibility of the present invention according to its different aspects. The micro-electromechanical system has been placed under vacuum and more particularly at a pressure lower than 1 millibar. Its resonance frequency f₀ is substantially equal to 71.5 kHz and has a quality factor Q equal to 1,100 and a non-linearity coefficient α equal to 40 kHz/V². This type of resonator 2 is generally used as a generator and detector of acoustic waves. The peak voltage V₀ of the excitation signal applied to the resonator 2 is between 0.1 V and 10 V; a peak voltage equal to 5 V is primarily used. The excitation frequency f of the excitation signal is substantially equal to the resonance frequency f₀ of the resonator 2. By using such an excitation signal, the resonator 2 considered herein is set in a so-called Duffing mode. The hysteresis is then generated over a frequency domain 111 with an extent substantially equal to α·V₀². To confer a chaotic behaviour on the resonator 2, the modulation frequency δf of the excitation signal is determined by both the extent of the frequency domain 111 and the bandwidth f₀/Q of the resonator 2. The value of the modulation frequency δf can vary, in particular due to its dependence on the extent of the frequency domain 111 and on the bandwidth f₀/Q of the resonator 2, depending on whether the peak voltage V₀, the excitation frequency f and/or the resonance frequency f₀ is modulated 120. The values of the modulation frequency δf to be used can be determined numerically or be extrapolated from an already known resonator 2 by normalising it. The analog signal 102 thus obtained is demodulated at the excitation frequency f. On this demodulated signal, a sampling is performed at a sampling frequency dependent of the modulation frequency δf. Preferably, the sampling frequency is at least 10 times higher than the modulation frequency δf. For example, the modulation frequency can vary from 50 Hz to 5 kHz, and the sampling frequency can vary from 500 samples per second to 50,000 samples per second. The conversion 140 has been performed with a 64-bit accuracy, reduced to an 8-bit accuracy to simulate an 8-bit analog-to-digital converter at the output of the resonator 2. Hence, each value of the digital signal 104 is encoded over 8 bits, of which only the n bits with the lowest weight, typically the 3 bits with the lowest weight, have been retained. A random binary sequence has thus been generated 150 which complies with 13 of the 15 reference tests known under the reference NIST 800-22, with a sampling rate equal to about 10 kbits/sec.

The invention is not limited to the aforementioned embodiments, and includes all the embodiments covered by the claims.

For example, the demodulation step 135 may also be carried out after conversion 140 of the analog signal 102, on the digital signal derived from the conversion 140.

For example, only one amongst the analog signal 1021 and the analog signal 1022 can be enough to generate 150 a sequence of true random numbers. In which case, the logical operation 156 is not carried out and the splitting step (not represented) consists in splitting a corresponding one amongst the two series of bits 1041 and 1042.

For example, the excitation device 11 of the excitation system 10 intended to be integrated into a micro-electromechanical system 1 comprising a resonator 2 for use thereof in the generation 150 of a sequence of true random numbers on the basis of said analog signal 102 can serve only as a modulation 120 of the excitation signal, the latter being generated by one or more component(s) already equipping the micro-electromechanical system 1.

For example, each of the values of resonance frequency f₀ and of quality factors Q given hereinabove can be substantially modulated within a set of available range of values, i.e. about 200 Hz to 10 GHz for the resonance frequency f₀ and about 10 to 10⁶ for the quality factor Q, yet without altering the possibility of implementation of the invention. The excitation force applied to the resonator 2 and the non-linearity of the behaviour of the resonator 2 induced by this excitation force can vary with respect to the values indicated hereinabove so as to find a system equivalent to the studied one to demonstrate the feasibility of the invention. Similarly, the initial conditions in which the resonator 2 is can vary; for example, the resonator 2 may be placed under a pressure equal to 1 bar. Furthermore, the sampling rate depends on the parameters of the considered resonator 2; it can easily vary between 1 bit/sec and 1 Mbits/sec depending on the resonance frequency f₀, the quality factor Q and the extent of the frequency domain 111.

1. An excitation system for a resonant physical component, the system comprising an excitation device configured to:
excite the resonant physical component with a determined excitation signal to set the resonant physical component in a dynamic multi-stability mode, and
modulate the excitation signal,
so that the resonant physical component has a chaotic behaviour and that an analog signal originating from the resonant physical component is representative of the chaotic behaviour of the resonant physical component,
the excitation system having no feedback loop.

2. The excitation system according to claim 1, intended to be integrated into a micro-electromechanical system comprising a resonant physical component for use thereof in the generation of a sequence of true random numbers on the basis of said analog signal.

3. The excitation system according to claim 1, further comprising:
an analog-to-digital converter configured to convert the analog signal originating from the resonant physical component into a digital signal representative of the analog signal,
a digital processing device configured to generate a sequence of true random numbers on the basis of said digital signal.

4. The excitation system according to claim 1, further comprising a demodulation device configured to implement either one of the following steps:
before conversion of the analog signal, a demodulation of the analog signal at the frequency f of the excitation signal, and
after conversion of the analog signal, a demodulation of the digital signal at the frequency f of the excitation signal.

5. A chaotic physical true random number generator including:
a resonant physical component,
an analog-to-digital converter configured to convert an analog signal originating from the resonant physical component into a digital signal representative of the analog signal,
a digital processing device configured to generate a sequence of true random numbers on the basis of said digital signal,
wherein the generator further comprises an excitation device of the physical component resonant configured to:
excite the resonant physical component with a determined excitation signal to set the resonant physical component in a dynamic multi-stability mode, and
modulate the excitation signal,
so that the resonant physical component has a chaotic behaviour and that the analog signal to be converted is representative of the chaotic behaviour of the resonant physical component,
the excitation device having no feedback loop.

6. The generator according to claim 5, wherein the analog signal to be converted is representative of the changes in amplitude and/or phase of vibration of the resonant physical component excited by the modulated excitation signal.

7. The generator according to claim 5, wherein said dynamic multi-stability mode is a non-linear dynamic bistable mode called Duffing mode.

8. The generator according to claim 5, wherein said excitation signal has a peak voltage comprised between 0.01 and 10V and a frequency f equal to the resonance frequency f₀ of the resonant physical component within a 20% margin.

9. The generator according to claim 5, wherein said modulated excitation signal has a modulation frequency δf higher than the ratio f₀/Q of the resonance frequency f₀ of the resonant physical component to its quality factor Q.

10. The generator according to claim 5, wherein the resonant physical component comprises a micro/nano-resonator, such as a double-embedded micro/nano-beam.

11. The generator according to claim 5, further comprising a demodulation device configured to implement either one of the following steps:
before conversion of the analog signal, a demodulation of the analog signal at the frequency f of the excitation signal, and
after conversion of the analog signal, a demodulation of the digital signal at the frequency f of the excitation signal.

12. A method for generating true random numbers comprising the following steps:
excitation of a resonant physical component with a determined excitation signal to set the resonant physical component in a dynamic multi-stability mode,
modulation of the excitation signal, so that the resonant physical component has a chaotic behaviour,
the excitation and modulation steps being implemented by an excitation device with no feedback loop,
acquisition of an analog signal, originating from the resonant physical component and representative of the chaotic behaviour of the resonant physical component,
conversion of the analog signal into a digital signal representative of the acquired analog signal, then
generation of a sequence of true random numbers from said digital signal.

13. The method according to claim 12, wherein the excitation signal is parameterised to set the resonant physical component in a non-linear dynamic bistable mode called Duffing mode.

14. The method according to claim 12, wherein, the dynamic multi-stability mode of the resonant physical component being associated with a continuous and limited frequency domain, the frequency f of the excitation signal is determined to set the resonant physical component in a sub-mode of the dynamic multi-stability mode, said sub-mode being associated with a first half, and possibly a first third, of the frequency domain associated with the dynamic multi-stability mode of the resonant physical component.

15. The method according to claim 12, wherein the excitation of the resonant physical component comprises the application at its terminals, as an excitation signal, of a peak voltage comprised between 0.01 and 10V and a frequency f equal to the resonance frequency f₀ of the resonant physical component within a 20% margin.

16. The method according to claim 12, wherein the potential of the resonant physical component in its dynamic multi-stability mode having two distinct wells:
the frequency modulation of the excitation signal has a determined amplitude δf to induce changes in the state of the resonant physical component in its dynamic multi-stability mode from one of the two potential wells to the other, and vice versa, and/or
the amplitude modulation of the excitation signal has a determined amplitude δf to induce changes in the state of the resonant physical component from its monostable mode to its dynamic multi-stability mode, and vice versa.

17. The method according to claim 12, wherein the excitation signal is modulated with a modulation frequency δf higher than the ratio f₀/Q of the resonance frequency f₀ of the resonant physical component to its quality factor Q.

18. The method according to claim 12, further comprising either one of the following steps:
before conversion of the analog signal, a demodulation of the analog signal at the frequency f of the excitation signal, and
after conversion of the analog signal, a demodulation of the digital signal at the frequency f of the excitation signal.

19. (canceled)

20. The method according to claim 12, wherein the conversion of the analog signal comprises sampling of the analog signal at a sampling frequency or in steps selected according to the voltage of the excitation signal and a modulation frequency δf with which the excitation signal is modulated.

21. The method according to claim 12, wherein an analog signal representative of changes in amplitude of vibration of the resonant physical component and an analog signal representative of changes of phase of the resonant physical component being acquired during the acquisition step, the conversion step comprises the conversion of each of these two analog signals into a digital signal.

22. (canceled)

23. (canceled)

24. (canceled)

25. (canceled)

26. (canceled)
